(19) United States
(12) Patent Application Publication
(10) Pub. No.: US 2012/0281212 A1
(43) Pub. Date: Nov. 8, 2012

(54) SELF-COLLECTING SERS SUBSTRATE

(76) Inventors: David Fattal, Mountain View, CA (US); Zhiyong Li, Redwood City, CA (US)

(21) Appl. No.: 13/384,954

(22) PCT Filed: Jan. 29, 2010
(86) PCT No.: PCT/US10/22579

§ 371 Date: Jan. 19, 2012

(51) Int. Cl. G01N 21/01; G01N 21/65

(52) U.S. Cl. 356/301; 356/244

(57) ABSTRACT

A self-collecting substrate (10) for surface enhanced Raman spectroscopy having a first surface (10a) and a second surface (10b) opposed thereto, comprising: a waveguiding layer (10′) supported on a support layer (10″), with the waveguiding layer associated with the first surface and the support layer associated with the second surface; and a plurality of metal nano-antennae (14) established on the first surface and operatively associated with the plurality of openings such that exposure of analyte (18) to the light causes preferential aggregation of the analystes in the vicinity of the nano-antennae. A system (50) for at least one of attracting the analytes 18) to the metal nano-antennae (14) and performing surface enhanced Raman spectroscopy using the substrate (10) and a method for increasing a signal for surface enhanced Raman spectroscopy are provided.

### STATEMENT OF GOVERNMENT INTEREST

This invention has been made with Government support under Contract No. HR0011-09-3-0002, awarded by the Defense Advanced Research Projects Agency. The government has certain rights in the invention.

### TECHNICAL HELD

Embodiments of the present invention relate generally to systems for performing surface-enhanced Raman spectroscopy (SERS).

### BACKGROUND ART

Raman spectroscopy is a spectroscopic technique used in condensed matter physics and chemistry to study vibrational, rotational, and other low-frequency modes in molecular systems. In a Raman spectroscopic experiment, an approximately monochromatic beam of light of a particular wavelength range passes through a sample of molecules and a spectrum of scattered light is emitted. The spectrum of wavelengths emitted from the molecule is called a “Raman spectrum” and the emitted light is called “Raman scattered light” A Raman spectrum can reveal electronic, vibrational, and rotational energies levels of a molecule. Different molecules produce different Raman spectrums that can be used like a fingerprint to identify molecules and even determine the structure of molecules.

Raman spectroscopy is used to study the transitions between molecular energy states when photons interact with molecules, which results in the energy of the scattered photons being shifted. The Raman scattering of a molecule can be seen as two processes. The molecule, which is at a certain energy state, is first excited into another (either virtual or real) energy state by the incident photons, which is ordinarily in the optical frequency domain. The excited molecule then radiates as a dipole source under the influence of the environment in which it sits at a frequency that may be relatively low (i.e., Stokes scattering), or that may be relatively high (i.e., anti-Stokes scattering) compared to the excitation photons. The Raman spectrum of different molecules or matters has characteristic peaks that can be used to identify the species. As such, Raman spectroscopy is a useful technique for a variety of chemical or bio-logical sensing applications. However, the intrinsic Raman scattering process is very inefficient, and rough metal surfaces, various types of nano-antennae, as well as waveguiding structures have been used to enhance the Raman scattering processes (i.e., the excitation and/or radiation process described above).

The Raman scattered light generated by a compound (or ion) adsorbed on or within a few nanometers of a structured metal surface can be 10³-10¹⁴ times greater than the Raman scattered light generated by the same compound in solution or in the gas phase. This process of analyzing a compound is called surface-enhanced Raman spectroscopy (“SERS”). In recent years, SERS has emerged as a routine and powerful tool for investigating molecular structures and characterizing interfacial and thin-film systems, and even enables single-molecule detection. Engineers, physicists, and chemists continue to seek improvements in systems and methods for performing SERS.

Most SERS systems only enhance the electro-magnetic field at certain hot spots. While this can be very desirable, in many cases, the analytes are spread evenly on the SERS substrate, such as by simple adsorption. However, only a small fraction of the analytes actually populate the hot spots.

### BRIEF DESCRIPTION OF THE DRAWINGS

Features and advantages of embodiments of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a cross-sectional view, illustrating an exemplary SERS structure in conjunction with a method for increasing the analyte density at hot spots in accordance with an embodiment of the invention.

FIG. 2 is a perspective view of the embodiment of FIG. 1 in accordance with an embodiment of the invention.

FIG. 3 is a flow chart describing a method of increasing the analyte dencity at hot spots in accordance with an embodiment of the invention.

FIG. 4 is a semi-schematic perspective view of another embodiment of a light amplifying device of the present disclosure.

FIG. 5 is a semi-schematic perspective view of still another embodiment of a light amplifying device of the present disclosure.

FIGS. 6A-6B each depict a schematic view of a sensing apparatus, according to an embodiment of the present invention.

### BEST MODES FOR CARRYING OUT THE INVENTION

Reference is made now in detail to specific embodiments, which illustrates the best mode presently contemplated by the inventors for practicing the invention. Alternative embodiments are also briefly described as applicable.

In accordance with the teachings herein, a structure and method are provided for concentrating analytes in solution onto metal nano-antennae to thereby improve the concentration threshold for SERS detection. A SERS substrate is provided that may be termed “self-collecting” in that an illumination of the substrate during deposition of the analyte concentrates the analytes onto the metal nano-antennae. The SERS substrate is provided with a resonant grating, but not necessary limited to the grating design shown. The combination of the resonant grating and the metal nano-antennae creates a high electric field (Efield), which attracts the analyte to the “hot-spot” generated by the high E-field.

The SERS substrate, upon illumination, attracts the analytes automatically to the SERS-active regions or “hot-spots”, thereby increasing the SERS signal for very dilute solutions, i.e., improving the detection limit. Alternatively, in some embodiments, the resonant grating may be eliminated, and illumination of the substrate with just the metal nano-antennae may be employed to attract the analytes to the SERS-active regions. However, the combination of the resonant grating and the metal nano-antennae provides improved results over the metal nano-antennae alone.

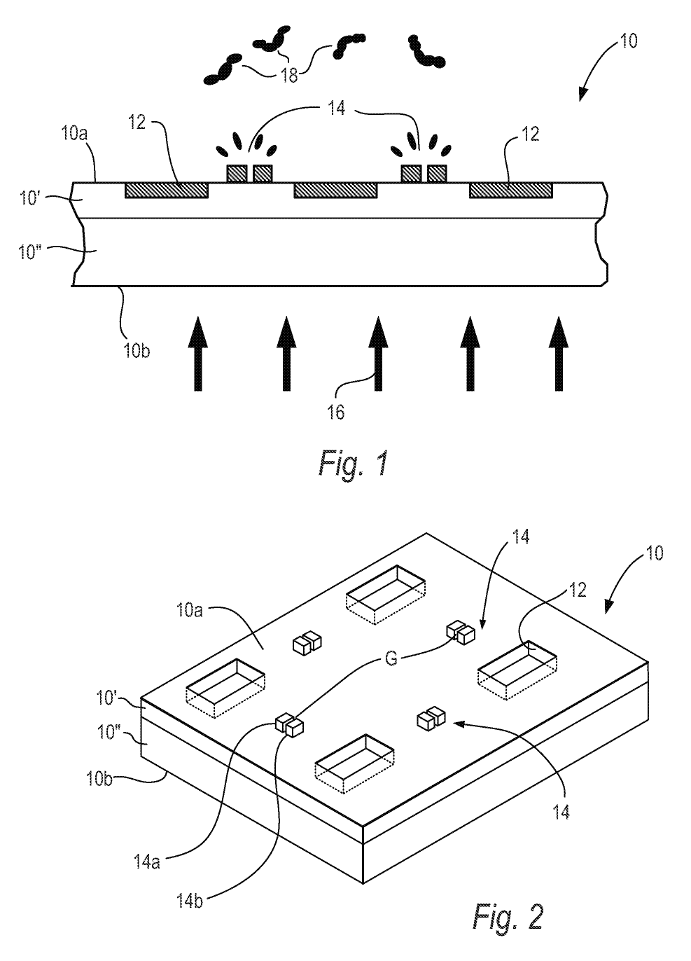

Referring now to FIGS. 1 and 2, an embodiment of the self-collecting SERS substrate 10 is depicted. The substrate 10 has two major opposed surfaces, a “top” surface 10a and a “bottom” or backside surface 10b. The substrate 10 includes a resonant grating 12 comprising a plurality of openings formed in the surface 10a of the substrate and a plurality of metal nano-antenna 14 formed on the surface 10a of the substrate. The metal nano-antennae 14 are formed between the openings comprising the resonant grating 12.

The resonant grating 12 has a period of a few hundred nm. For example, in some embodiments, the period may be within the range of about 200 to 500 nm. In some embodiments, the height of the openings comprising the resonant grating may be within the range of about 20 to 500 nm.

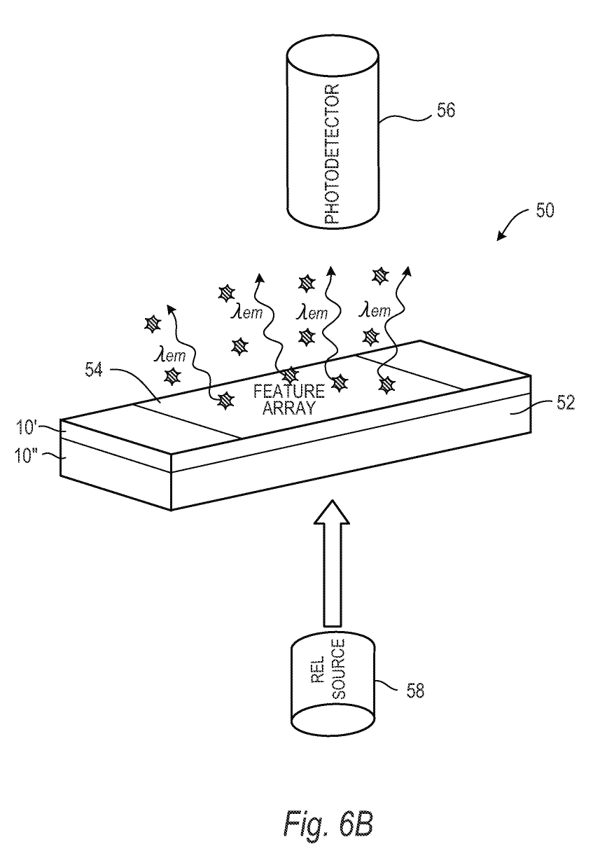

Backside illumination by light 16 is incident on the back surface 10b of the substrate 10. Analyte moieties 18 in solution are attracted to the metal nano-antennae due to the high E-field that is created by the combination of the resonant grating 12 and the metal nano-antennae 14. However, while backside illumination is specifically depicted in FIG. 1, it will be appreciated that the illumination by light 16 may alternatively be incident on the front surface 10a of the substrate: see, e.g., FIG. 6A and the discussion associated with FIGS. 6A-6B.

The substrate 10 comprises a dielectric material that is transparent to the wavelength of the incident light 16. The wavelength of the incident light 16 is in the visible to mid-IR (or about 400 nm to 3,000 nm), and may be continuous or pulsed.

Non-limiting examples of suitable substrate 10 materials include insulators (e.g., glass, quartz, ceramic, alumina, silica, silicon nitride, etc.), polymeric materials (e.g., polycarbonate, polyamide, acrylics, etc.), or semiconductors (e.g., silicon, InP, GaAs, InAs, GaₓAl₁₋ₓAs (where 0<x<1), InₓGa₁₋ₓAs_{y}P_{1-y} (where 0<x<1, 0<y<1)), silicon-on-insulator (SOI) substrates, nitride-onoxide substrates (e.g., silicon nitride on oxide), or group I MN semiconductors established on silicon or 301 substrates, or combinations thereof.

The substrate 10 comprises two layers, a top layer 10′ that forms a waveguiding structure and a bottom layer 10″ that provides support for the strutture. The openings that comprise the resonant grating 12 are formed in the top, or waveguiding, layer 10′. The thickness of the top layer 10′ is about 50 to 500 nm; this layer may comprise any of the common waveguiding materials, including those listed above. The thickness of the bottom layer 10″ is in the range of several hundred micrometers to millimeters; this layer may comprise any of the common substrate materials, including those listed above. However, the material used for the waveguiding layer 10′ may be different than the material used for the support layer 10″. Also, if frontside illumination is used for both for concentrating analytes 18 onto the nano-antennae 14 and for SERS analysis, then a material that is opaque to light may be employed as the support layer 10″.

The resonant grating 12 comprises openings that are formed in the top surface 10a of the substrate 10, and the nano-antennae 14 are established on the top surface, as is more clearly shown in FIG. 2.

In an embodiment, the openings of the resonant grating 12 are formed via some form of lithography (e.g., optical lithography, electron-beam lithography, nano-imprint lithography, etc.) followed by a dry or wet etching technique commonly used in CMOS and III-V semiconductor processing. A non-limiting example of the dry etching includes Reactive on Etching (RIE) using fluorine, chlorine, and/or methane based gas(es), and non-limiting examples of wet etching utilize HCl, HF, sodium hydroxide, ammonium hydroxide, nitric acid, and/or sulfuric acid based solutions. The openings 12 generally do not extend through the entire thickness of the substrate 10.

As shown in FIG. 2, the openings 12 be cuboid (or rectangular prism) in shape or may be a square prism where at least two of the lengths (height and base) are the same or may be a cube, where all three lengths (height and base) are equal. However, it is to be understood that the openings 12 may have any suitable geometry, so long as a periodic array is formed. While a few openings 12 are shown in FIG. 2, it is to be further understood that any number of openings may be formed, and that the number of openings may depend, at least in part, on the number of antennae 14 to be included on the surface 10a. In one embodiment, the number of openings 12 ranges from an array of 10×10 to greater than 100×100. In one non-limiting example, the array includes 10×120 openings 12. In another non-limiting example, the array includes 100×100 openings 12. Furthermore, in some instances, the array will have the same periodicity in both directions (X and Y).

As described further herein, the openings of the resonant grating 12 in combination with the incident light create a high electric field spatially distributed along the top surface. It is to be understood that the corresponding frequency is determined, at least in part, by the periodicity of the resonant grating array 12 and the desired Raman wavelength. More particularly, the corresponding frequency may be calculated via the following equation:

$$\frac{λ}{Λ} = {n}_{eff} \pm sin θ$$

where λ is the vacuum wavelength, θ is the angle of incidence, A is the grating period, and n_{eff} is the effective index of the propagating mode in the guiding/dielectric layer 12.

The grating period is also dependent to some extent at least on the refractive index of the substrate 10. A lower index requires a larger grating period, while a higher index requires a smaller grating period.

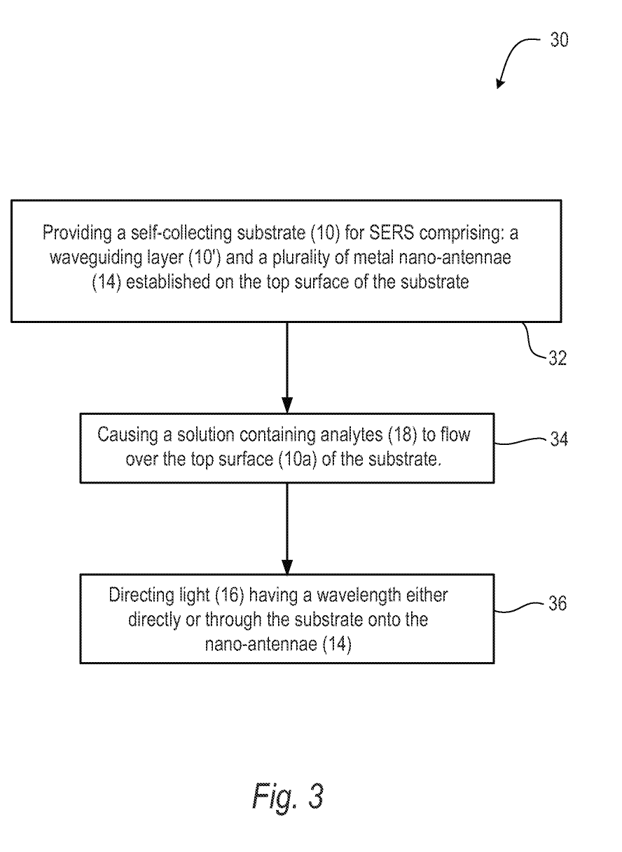

Each nano-antenna 14 established on the surface 10a of the substrate 10 includes at least one dimension (e.g., length (i.e., the length of one segment), width, height, etc.) that is on the nano-scale (e.g., from 1 nm to 200 nm). The nano-antenna 14 may have any suitable geometry, and often includes a gap G in which the material of interest to be studied via Raman spectroscopy is introduced. The embodiment of the nano-antenna 14 shown in FIG. 2 is a linear antenna (i.e., it extends in a single direction, with no curve or bend). The linear nano-antenna 14 includes two wire segments 14a, 14b having the gap G positioned therebetween. Such wire segments 14a, 14b (and thus optical antenna 14) are often made from plasmonic materials (e.g., noble metals such as gold and silver). It is to be understood that other nano-antenna 18 geometries may also be used. Non-limiting examples of such other geometries are cross antennae (shown in FIG. 3), bow-Lie antennae, and elliptic, spherical, or faceted nanoparticle antennae. The nanoparticle antennae 14 include two or more metallic particles that touch or have a small gap (e.g., less than 10 nm) therebetween. It is to be understood that the geometry of the antennae 14 may be altered such that it resonates at a desirable frequency.

The nano-antennae 14 may be formed via a lithography technique (e.g., optical lithography, electron-beam lithography, nano-imprint lithography, photo-lithography, extreme ultraviolet lithography, X-ray lithography, etc.), or via a combination of deposition and etching techniques, or via a combination of deposition and lift-off techniques, or via direct deposition techniques (e.g., using focused ion beam (FIB) or plating), or via assembly techniques (e.g., guided assembly or Langmuir-Blodgett method). In one non-limiting example, the antennae 14 are defined via a combination of lithography, metal evaporation, and liftoff techniques.

When the device 10 is properly designed (including desirable openings 12 and nano-antennae 14 geometries), light 16 having a corresponding frequency/angle is amplified. During its use, the electric field in a certain small area (i.e., the hot spot) around the antennae 14 is much stronger than that of the incident electromagnetic (EM) wave in a certain frequency range at or around the resonant frequency of the antenna 14. Consequently, a material of interest (or an object made of the material of interest), e.g., analyte 18, is attracted to the hot spot.

The Raman scattering of the analyte 18 is greatly enhanced in the excitation process, the radiation process, or, in some instances, both the excitation and radiation processes. This is due to the presence of the resonant grating 12 (including the openings 16). During use of the device 10, the material of interest (analyte 18) in solution is caused to flow over the nano-antennae while light 16 of a stimulating/exciting wavelength is directed toward the surface 10b. The resonant grating 12 creates a high E-field, about 10-fold compared to not having a resonant grating. The metal nano-antennae 14 provide a further enhancement in the E-field of 100× to 1,000×. The resulting high E-field, concentrated at the metal nano-antennae 14, creates the hot spots and exerts an attraction on small particles (analyte 18), much like the “optical tweezer” effect.

According to the principle of the optical tweezers (http://en.wikipedia.org/wiki/Optical_tweezers), a polarizable particle (having a polarizability a), e.g., analyte 18, is attracted to regions of space with the highest electric field. This effect is exploited in the SERS substrate 10 described herein, where the analytes 18 may be automatically attracted to the high field regions of space, near metallic particles, e.g., nano-antennae 14, illuminated by resonant light 16. By removing the resonant light 16, the analytes 18 under the fluidic flow can be released from the hot spot, which will allow the reuse of the same hot spot for repetitive and sensitive detection of analytes.

In the embodiment shown in FIGS. 1-2, the analytes 18 in solution are brought to within a reasonable distance of the metal nano-antennae 14. A microchannel (not shown) that exposes the nano-antennae 14 to the solution or immersion of the substrate 10 in the solution are examples of embodiments of bringing the analytes 18 close to the metal nano-antennae.

Once the optical trapping potential (½α |E|²) exceeds the kinetic energy of the incoming particle (and any thermal fluctuation energy˜kT), the particle 18 will be automatically directed to the very spot where the electric field is the brightest, giving a greatly enhanced Raman signal. The reason for using a microfluidic channel is that it allows control of the initial velocity of the particles (and hence their kinetic energy), and it can be made small enough to bring the analytes 18 within dose range of the metal nano-antennae 14 to initiate the trapping process. However, free space implementations may be possible.. The metal nano-antennae 14 may also be arranged in periodic arrays, as described above, for even greater field-enhancement via the surface plasmon—dielectric waveguide polariton effect.

The method steps related to attracting the analytes 18 to the metal nano-antennae 14 are illustrated in FIG. 3. The method 30 begins with providing 32 the self-collecting substrate 10 for surface enhanced Raman spectroscopy, comprising: a waveguiding layer 10′ supported on a support layer 10″; and a plurality of metal nano-antennae 14 established on the first surface. The wave-guiding layer is associated with the first surface 10a and the support layer is associated with the second surface 10b. Exposure of analyte 18 to the light 16 causes preferential aggregation of the analyte in the vicinity of the nano-antennae 14.

The next step involves causing 34 the solution containing the analytes 18 to flow over the top surface 10a of the substrate 10.

The final step involves directing 36 light 16 having a wavelength either directly or through the substrate 10 onto the nano-antennae 14. Steps 34 and 36 may be performed in either order. As a consequence of the method, a detection limit of the analyte 18 is improved.

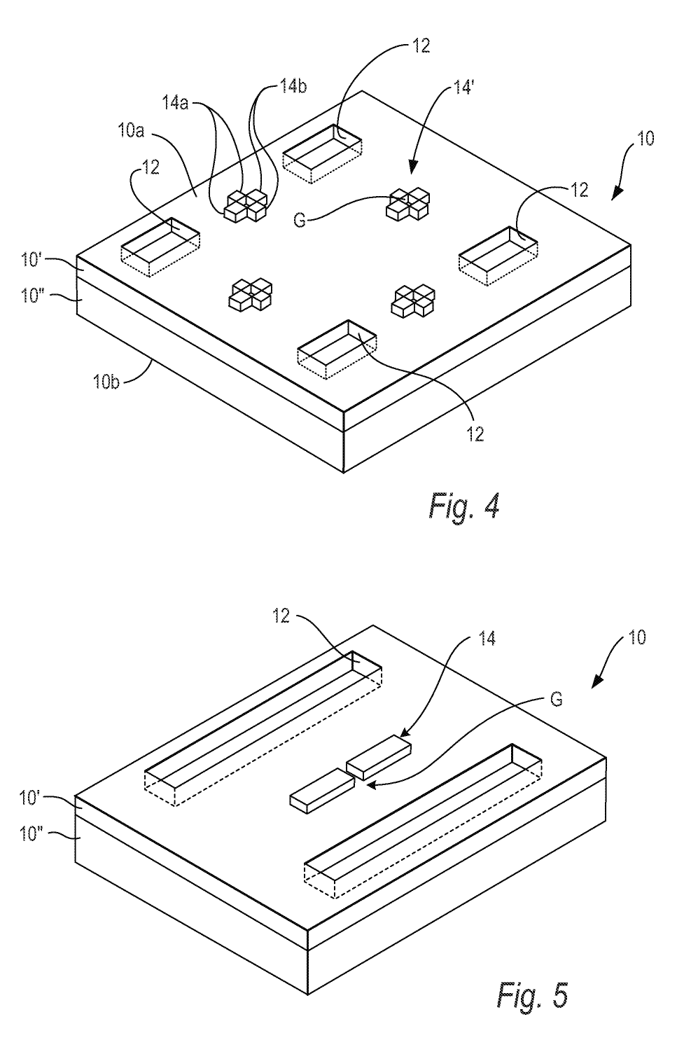

Referring now to FIG. 4, another embodiment of the self-collecting SERS substrate 10 is depicted. As in FIGS. 1-2, the openings 12 are formed in a portion of the substrate 10 using the methods described herein, and the nano-antennae 14′ are established on the surface 10a using the materials and methods described herein. In the embodiment shown in FIG. 4, the nano-antenna 14″ includes two respective antennae (each of which includes two segments 14a and 14b) that cross at a non-zero angle and share a gap G at their intersection.

When the device 10 is properly designed (including desirable openings 12 and nano-antennae 14′ geometries), light 16 having a corresponding frequency is incident on the backside 10b of the substrate. During its use, the electric field in a certain small area(i.e., the hot spot) around the nano-antennae 14′ is much stronger than that of the incident electromagnetic (EM) wave in a certain frequency range at or around the resonant frequency of the antenna 14′. As such, a material of interest (or an object made of the material of interest), e.g., analyte 18, is attracted to the hot spot. The resulting Raman scattering of this material 18 is greatly enhanced in either the excitation process, the radiation process or, in some instances, both the excitation and radiation processes. This is due, at least in part, to the high concentration of the analyte 18 in the hot spots, compared to more common analyte deposition methods that result in a relatively uniform deposition of analyte over the entire substrate surface.

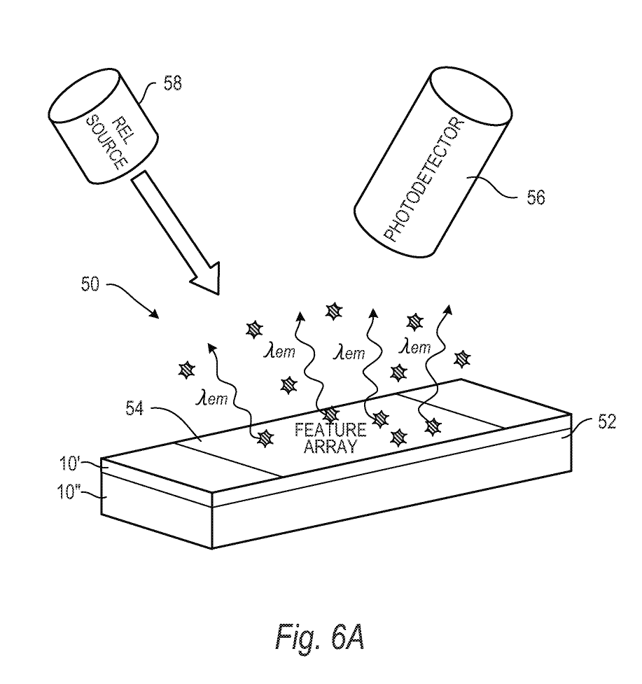

FIG. 5 depicts still another embodiment of the self-collecting SERS substrate 10. Similar elements and components to those described in reference to FIGS. 1-2 and 4 are included in the device 10 of FIG. 5, and thus the materials and techniques described in connection with such substrates 10 are suitable for the substrate 10 shown in FIG. 5. Specifically, yet another embodiment is illustrated for the configuration of the grating openings 12 and the metal nanoantennae 14.

The Raman-active systems described above with reference to FIGS. 1-2 and 4-5 can be implemented in analyte sensors that are used to identify one or more analyte molecules 18 by configuring the substrate 10 with the combination of grating 12 and nano-antennae 14, as described above.

The Raman-active material 18 disposed on the hot spots of the nano-antennae 14 further intensifies the Raman scattered light when illuminated by appropriate Raman excitation wavelengths. The Raman scattered light can be detected to produce a Raman spectrum that can be used like a finger print to identify the analyte.

FIGS. 6A-6B show schematic representations of analyte sensors configured and operated in accordance with embodiments of the present invention. Analyte sensor 50 includes a Raman-active substrate 52 composed of an array of features 54, as described above with reference to FIGS. 1-2 and 4-5 (grating 12 and nano-antennae 14), a photodetector 56, and a Raman-excitation light source 58.

In the example shown in FIG. 6A, the light source 58 is positioned so that Raman-excitation light is incident directly on the array of features 54 (the nano-antennae 14 alone or the combination of the nano-antennae and the resonant grating 12).

In the example shown in FIG. 6B, the light source 58 is positioned beneath the Raman-active substrate 52 so that the Raman-excitation light passes through the substrate. In both cases, the photodetector 56 is positioned to capture at least a portion of the Raman scattered light emitted by an analyte in the fluid.

The arrangement depicted in FIG. 6A, namely, the light source 58 positioned above the substrate 10, is also the same arrangement that may be used for attracting the analyte 18 to the nano-antennae 14. Likewise, the arrangement depicted in FIG. 6B, namely, the light source 58 positioned beneath the substrate 10, is also the same arrangement that may be used for attracting the analyte 18 to the nano-antennae 14. In this connection, the light source 58 may be used first to perform the frontside or backside illumination during analyte deposition. Following deposition, the same arrangement may be used in the SERS procedure. Alternatively, a separate light source may be employed (in either of the configurations depicted in FIGS. 6A-6B) to excite the nano-antennae 14.

The intensity of the Raman scattered light may also be enhanced as a result of two mechanisms associated with the Raman-active material. The first mechanism is an enhanced electromagnetic field produced at the surface of the Raman-active substrate 52, specifically, the nano-antennae 14 depicted in FIGS. 1-2 and 4-5. As a result, conduction electrons in the metal surfaces of the nano-antennae 14 are excited into an extended surface excited electronic state called a “surface plasmon polariton” or “localized surface plasmon”. Analytes 18 adsorbed on or in close proximity to the nano-antennae 14 experience a relatively strong electromagnetic field. Molecular vibrational modes directed normal to the nano-antennae 14 surfaces are most strongly enhanced. The intensity of the surface plasmon polariton resonance depends on many factors, including the wavelengths of the Raman excitation light.

The second mode of enhancement, charge transfer, may occur as a result of the formation of a charge-transfer complex between the surfaces of the nano-antennae 14 and the analyte 18 absorbed to the nano-antennae surfaces. The electronic transitions of many charge transfer complexes are typically in the visible range of the electromagnetic spectrum.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A self-collecting substrate (10) for surface enhanced Raman spectroscopy having a first surface (10a) and a second surface (10b) opposed thereto, comprising:
a waveguiding layer (10′) supported on a support layer (10″), with the waveguiding layer associated with the first surface and the support layer associated with the second surface; and
a plurality of metal nano-antennae (14) established on the first surface such that exposure of analyte (18) to the light causes preferential aggregation of the analyte in the vicinity of the nano-antennae.

2. The substrate (10) of claim 1 further comprising a resonant grating (12) comprising a plurality of openings in a periodic array formed in the waveguiding layer (10′),
wherein the plurality of nano-antennae (14) is operatively associated with the plurality of openings.

3. The substrate (10) of claim 2 wherein the metal nano-antennae (14) are spaced between the openings of the resonant grating (12).

4. The substrate (10) of claim 2 wherein the resonant grating (12) has an opening-to-opening period within a range of 200 to 500 nm and wherein the openings of the resonant grating (12) are cuboid in shape.

5. The substrate (10) of claims 1-4 wherein the wavelength is within a range of visible to mid-infrared.

6. The substrate (10) of claims 1-5 wherein exposure of analyte (18) to light is performed with a light source (16) positioned either to directly illuminate the first surface (10a) or the second surface (10b).

7. The substrate (10) of claim 6 wherein the support layer (10″) is either opaque for illumination of the first surface (10a) or transparent for illumination of the second surface (10b).

8. A system (50) for performing at least one of attracting the analytes (18) to the metal nano-antennae (14) and surface enhanced Raman spectroscopy, comprising:
the substrate (10) of claim 1; and
a light source (16, 58) operatively configured to direct light toward the nano-antennae (14) on the substrate, wherein the light source (16) may be the same or different as the light source (58).

9. The system (50) of claim 8 further comprising a resonant grating (12) comprising a plurality of openings in a periodic array formed in the waveguiding layer (10′),
wherein the plurality of nano-antennae (14) is operatively associated with the plurality of openings.

10. The system (50) of claims 8-9 wherein the light source (16) is positioned either to directly illuminate the first surface (10a) or the second surface (10b) to cause aggregation of the analyte (18) in the vicinity of the nano-antennae (14) and wherein the light source (58) is positioned either to directly illuminate the first surface (10a) or the second surface (lob), independently of the position of the light source (16).

11. The system (50) of claims 8-10, further comprising a detector (56) operatively positioned to detect an enhanced Raman signal from the analyte 18 positioned adjacent to at least a portion of the nano-antennae (14) of the substrate (10).

12. The system (50) of claims 8-11 wherein the light source (16) is either pulsed or continuous wave.

13. A method for increasing a signal for surface enhanced Raman spectroscopy, comprising:
providing the substrate (10) of claim 1;
in either order, causing a solution containing the analyte (18) to be exposed to the first surface (10a) of the substrate; and
directing light (16) either directly or through the substrate onto the nano-antenna (14),
whereby a detection limit of he analyte is improved.

14. The method of claim 13 wherein the substrate further comprises a resonant grating (12) comprising a plurality of openings formed in the waveguiding layer (10′), wherein the plurality of nano-antennae (14) is operatively associated with the plurality of openings.

15. The method of claims 13-14 wherein the illumination light is either pulsed or continuous wave.
